(19) United States
(12) Patent Application Publication
(10) Pub. No.: US 2024/0012671 A1
(43) Pub. Date: Jan. 11, 2024

(54) TRACKING AND SAVING POINT-IN-TIME HARDENING STATUS OF VIRTUAL MACHINE

(71) Applicant: VMWARE, INC., Palo Alto, CA (US)

(72) Inventors: LEENA SHUKLENDU SOMAN, Pune (IN); RUSHIT NILAY DESAI, Pune (IN); AMOL ABHAY KHARE, Pune (IN); KRISHNENDRA NANDI, Pune (IN); RANJIT TEJASINGH JADHAV, Pune (IN)

(21) Appl. No.: 17/903,108

(22) Filed: Sep. 6, 2022

(30) Foreign Application Priority Data
Jul. 8, 2022 (IN) 202241039325

(51) Int. Cl. G06F 9/455

(52) U.S. Cl. CPC G06F 9/45558; G06F 2009/4557; G06F 2009/45583

(57) ABSTRACT

A system is described providing ways to track and save the status of hardening processes performed by a hardening agent executing on a master virtual machine (VM) to prepared it for cloning. The hardening agent can produce progress updates for prerequisite hardening processes being carried out and the updates can be used by the management server to track and save the hardening state of the master VM. When the VM is powered off, the latest hardening state can be saved to make it available to administrators, and the hardening state can be automatically retained with a snapshot created of the master VM. When all prerequisite hardening processes are met, the master VM status is changed to indicate that it is ready to clone.

### RELATED APPLICATIONS

Benefit is claimed under 35 U.S.C. 119(a)-(d) to Foreign Application Serial No. 202241039325 filed in India entitled “TRACKING AND SAVING POINT-IN-TIME HARDENING STATUS OF VIRTUAL MACHINE”, on Jul. 8, 2022, by VMware, Inc., which is herein incorporated in its entirety by reference for all purposes.

### TECHNICAL FIELD

The present disclosure generally relates to virtual desktop infrastructure and more specifically to techniques for tracking and saving the hardening status of master virtual machines used for cloning.

### BACKGROUND

Virtual desktops provided as part of a virtual desktop infrastructure (VDI) or desktop -as-a-service (DAAS) offerings are becoming more commonplace in today's enterprise work environments. The security of having a remotely stored desktop, ability to access the desktop from any location and on any device, centralized desktop management, efficient use of hardware resources, as well as numerous other benefits made possible by VDI/DAAS are a large benefit for many organizations.

In a conventional VDI or DAAS environment, each user in an enterprise is provisioned a virtual desktop and is allowed to access his or her virtual desktop over a remote network connection, such as a WAN connection. The virtual desktops are typically hosted on servers that reside in a data center of the enterprise or a third-party service provider, and each host server may execute multiple virtual desktops. Users can utilize a client device to remotely log into their individual virtual desktop and all of the application execution takes place on the remote host server which is linked to the local client device over a network using a remote display protocol, such as Remote Desktop Protocol (RDP), PC-over-IP protocol (PCoIP), virtual network computing (VNC) protocol, or the like. Using the remote display protocol, the user can interact with applications of the virtual desktop, which are running on the remote host server, with only the display, keyboard, and mouse information communicated with the local client device. A typical implementation of this approach is to host multiple desktop operating system instances on separate virtual machines deployed on a server hardware platform running a hypervisor.

A common way for providing virtual desktops in the enterprise is by cloning a “master” or “golden” virtual machine (VM). Generally, the master VM is created and maintained by administrators and a pool of clone VMs is produced from it. However, because issues and vulnerabilities present on the master VM are inherited by the clones, administrators are tasked with the responsibility of ensuring that the master VM is secure, compliant, and otherwise free of issues that can expose or burden the VM clones that are provisioned to end-users. This process of preparing the master VM for cloning is referred to herein as “hardening”.

For example, to prepare the master VM for cloning, administrators may need to launch the master VM and carry out various procedures to ensure that the VM is secure, compliant, free of viruses and malware, and so on. Such procedures may involve running certain agents, virus scans and other tools, as well as performing various manual checks on the VM based on policies, etc. After checking progress and status of the various scans and performing any other checks, the administrator would make a manual decision of whether the master VM is ready for cloning. This process involves several time-consuming and burdensome manual steps and introduces the potential of human errors. What is needed is a more efficient way for tracking and saving the hardening status of master virtual machines used for cloning.

### BRIEF DESCRIPTION OF THE DRAWINGS

FIG. 1 illustrates an example of a virtual desktop environment, in accordance with various embodiments.

FIG. 2 illustrates an example architecture of a system for tracking and saving point-in-time hardening status of a master virtual machine, in accordance with various embodiments.

FIG. 3 illustrates an example architecture of a system for tracking and saving point-in-time hardening status of a master virtual machine implementing a virtual appliance, in accordance with various embodiments.

FIG. 4 illustrates an example process flow for tracking and saving point-in-time hardening status of a master virtual machine, in accordance with various embodiments.

FIG. 5 illustrates an example of some general components of a computing device, in accordance with various embodiments.

### DETAILED DESCRIPTION

Systems and methods in accordance with various embodiments of the present disclosure overcome at least some of the above-mentioned shortcomings and deficiencies by providing more efficient ways to track and save the hardening status of master virtual machines (VMs) used for cloning. In particular, embodiments described herein leverage a mechanism for communicating the status of hardening processes carried out by a hardening agent running on the master VM to a management server, which can be a centralized management platform and framework for managing host servers and their respective VMs in the VDI environment. The management server can track and save the status of the hardening process for the master VM and make the information available to administrators without the need to access the master VM itself. Consequently, an administrator desiring to clone a particular master VM is able to quickly and conveniently check the hardening status of the master VM and determine whether the master VM is ready for cloning, without the need to access or launch the master VM itself.

The process can begin by launching the master VM and executing the hardening agent in the master VM to perform various hardening processes in the master VM. A hardening process can comprise various types of process, such as a virus scan, vulnerability assessment, etc. that is carried out before the master VM is deemed suitable for cloning, as will be described in further detail below.

In various embodiments, as the hardening agent carries out each process, it can generate periodic status updates for the process, and the status updates can be shared with the management server. The management server can save and track these updates and make them available to administrators for viewing. When a master VM is powered off, the latest status of the hardening processes can be saved so that an administrator can view the status of each hardening process without needing to power up and access the master VM. Further, when a master VM completes all hardening processes that are deemed to be required (prerequisite processes), as may be defined by administrators, the master VM status in the management server can be set to “ready to clone” (e.g., status can be set that indicates that the master VM is ready for cloning), and an indication can be provided in the management server user interface that inform administrators that the master VM is ready for cloning.

As used throughout this disclosure in the context of remote desktop environments, the terms, “desktop”, “remote desktop”, and “virtual desktop” are used interchangeably and refer to an instance of an operating system and/or applications that run(s) remotely with respect to the user. In a conventional VDI or DAAS environment, each virtual desktop corresponds to a virtual machine (VM) executed on a host server (i.e., a host computing device) that is physically located in a remote datacenter. Each host server may host any number of virtual machines (e.g., tens, hundreds, etc.) and each virtual machine may be owned by an individual user. The virtual machine typically includes a guest operating system (e.g., Windows) capable of executing applications for the user and the virtual machine is used to provide a virtual desktop for the individual user. The user who owns the virtual desktop can remotely log into his or her virtual desktop using a client device that establishes a network connection (e.g., Wide Area Network connection) with the host server and remotely execute various applications on the virtual machine as if the desktop was running on the user's local client device. The client device can be any computing device capable of establishing a network connection, including but not limited to personal computers (PCs), laptops, mobile phones, tablet computers, wearable devices (e.g., smart watches, electronic smart glasses, etc.) or the like.

When a client device is accessing a remote desktop using a remote display protocol (e.g., RDP, PCoIP, VNC, etc.), the graphical user interface (GUI) of the desktop is generated on the server, the GUI image data is then encoded and transmitted over the network to the client device, where it is decoded and displayed to the user. For example, in one embodiment, the framebuffer pixel data on the server is encoded using a codec, such as H264, and transmitted over an Internet connection to the client, where the data is decoded and rendered on a local display screen to the user. Similarly, any user input information, such as keyboard and mouse events, is transmitted from the client device to the server over the network connection, where it may in turn cause various updates to the GUI of the remote desktop. In this manner, the user is able to view the GUI of the remote desktop and interact with it as if the desktop was actually running on the local client device, even though the desktop is actually executing remotely.

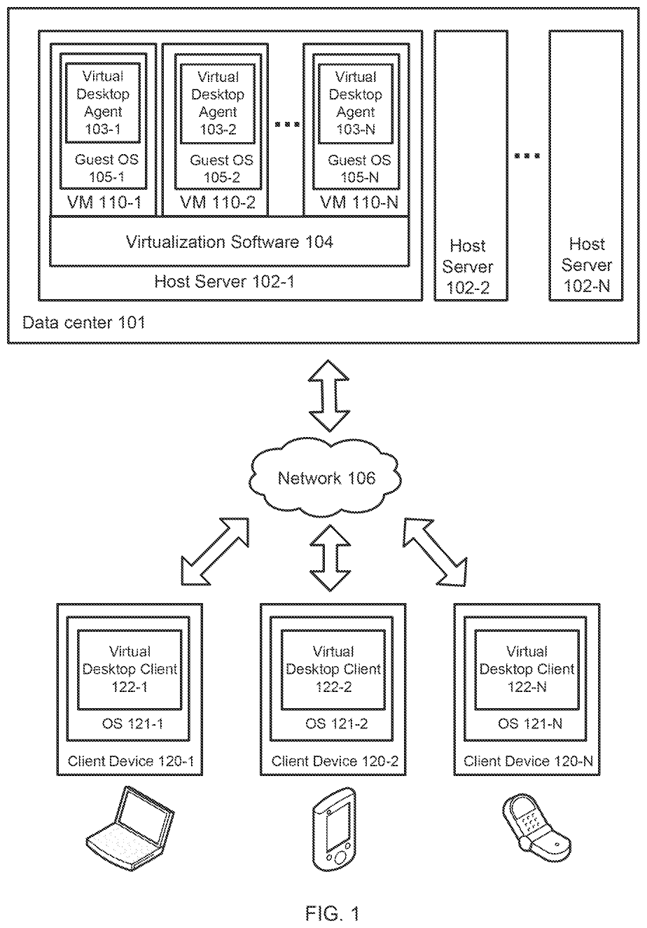

FIG. 1 illustrates an example of a virtual desktop environment, in accordance with various embodiments. The virtual desktop environment, such as VDI or DAAS environment, includes host servers (102-1, 102-2, 102-N) that are communicatively coupled with a number of client devices (120-1, 120-2, 120-N) via a network 106. Network 106 may be a wide area network (WAN), or other form of remote communication link between the host servers (102-1, 102-2, 102-N) and client devices (120-1, 120-2, 120-N). Network 106 may further include numerous other components, such as one or more firewalls, connection brokers, management servers, etc., which are not shown here so as not to obscure salient features of the remote desktop environment. Host servers (102-1, 102-2, 102-N) may physically reside in a data center 101 of the enterprise (e.g., in case of VDI) or in a data center of a third-party service provider (e.g., in case of DAAS).

By way of illustration, host server 102-1 can interoperate with client devices (120-1, 120-2, 120-N) to provide virtual desktop services to users of client devices (120-1, 120-2, 120-N). For example, host server 102-1 can host, for each user, a desktop that is presented by a guest operating system (such as one of the guest operating systems 105-1, 105-2, 105-N) running on a virtual machine (such as one of the virtual machines 110-1, 110-2, 110-N) on host server 102-1. In this context, the terms “desktop”, “remote desktop”, and “virtual desktop” refer to a computing environment in which a user can launch, interact with, and manage the user's applications, settings, and data. Each client device (120-1, 120-2, 120-N) can allow a user to view on a desktop graphical user interface (on a local display device) his/her desktop that is running remotely on host server 102-1, as well as provide commands for controlling the desktop. In this manner, the users of client devices (e.g., 120-1, 120-2, 120-N) can interact with the desktops hosted on host server 102-1 as if the desktops were executing locally on client devices (120-1, 120-2, 120-N).

In the embodiment of FIG. 1, host server 102-1 includes virtualization software 104 that supports the execution of one or more virtual machines (VMs) (e.g., 110-1, 110-2, 110-N). The virtualization software 104 may be a hypervisor, a virtual machine manager (VMM) or other software that allows multiple virtual machines to share the physical resources of the server. In the illustrated embodiment, each virtual machine (e.g., 110-1, 110-2, 110-N) can execute a guest operating system (e.g., 105-1, 105-2, 105-N) that hosts a desktop for a single user at a time. For example, if five users connect to host server 102-1 for the purpose of initiating remote desktop sessions, the host server 102-1 can launch five VMs, each hosting one desktop for each one of the five users. These types of virtual desktop environments where user desktops are hosted within separate, server-side virtual machines are often referred to as virtual desktop infrastructure (VDI) or Desktop-as-a-Service (DAAS) environments.

In such virtual desktop environments, each client device (e.g., 120-1, 120-2, 120-N) can execute a virtual desktop client (e.g., 122-1, 122-2, 122-N). For example, the virtual desktop client (e.g., 122-1, 122-2, 122-N) can be a stand-alone, designated client application (“native client”), or a web browser (“web client”). In some cases, a standard web browser may be modified with a plugin to operate as a web client. The interaction between the virtual desktop and the client device can be facilitated by such a virtual desktop client (e.g., 122-1, 122-2, 122-N) running in the OS (e.g., 121-1, 121-2, 121-N) on the client device (e.g., 120-1, 120-2, 120-N) which communicates with a server-side virtual desktop agent (e.g., 103-1, 103-2, 103-N) that is running on the guest OS inside the virtual machine (e.g., 110-1, 110-2, 110-N). In particular, the interaction can be performed by the virtual desktop agent transmitting encoded visual display information (e.g., framebuffer data) over the network to the virtual desktop client and the virtual desktop client in turn transmitting user input events (e.g., keyboard, mouse events) to the remote desktop agent.

It should be noted that the particular virtual desktop environment illustrated in FIG. 1 is shown purely for purposes of illustration and is not intended to be in any way inclusive or limiting to the embodiments that are described herein. For example, a typical enterprise VDI deployment would include many more host servers, which may be distributed over multiple data centers, which might include many other types of devices, such as switches, power supplies, cooling systems, environmental controls, and the like, which are not illustrated herein. Similarly, a single host server would typically host many more virtual machines than what is shown in this illustration. It will be apparent to one of ordinary skill in the art that the example shown in FIG. 1, as well as all other figures in this disclosure have been simplified for ease of understanding and are not intended to be exhaustive or limiting to the scope of the invention.

As mentioned previously, a common way for providing virtual desktops in the enterprise is by cloning a “master” or “golden” VM. Generally, the master VM is created and maintained by administrators on a management server and a pool of clone VMs can be produced from it. The master VM can serve as a template or base for cloning other VMs. For example, once the master VM is ready for cloning, a snapshot can be taken of the master VM or an image of the master VM can be captured, and the snapshot/image can be used to make clones. The snapshot can be copied into or reverted into a new VM every time the master VM is cloned, for example.

Generally, before the master VM is cloned, administrators need to make sure that the master VM meets various prerequisites, so that the clones perform to expectations. For example, if the master VM has certain vulnerabilities when it is cloned, then the clones can inherit those vulnerabilities. Hence, administrators need to make sure that the master VM if free of such issues before the cloning process is initiated.

The process of ensuring that a VM meets certain prerequisites before it is cloned is referred to herein as “hardening” of the VM. For example, hardening of the master VM may include performing processes such as an anti-virus scan, vulnerability assessment, CIS (Center for Internet Security®) benchmark compliance checking, and any other processes deemed necessary (e.g., by administrators) for ensuring that the master VM is ready for cloning. For example, hardening can include performing checks of settings in the operating system (OS) of the master VM, making sure that all updates and patches (for the OS and/or applications) are complete, checking network settings and firewalls, performing configuration checks, checking that passwords meet requirements and are not expired, or any other processes and assessments that the administrators may deem necessary before the VM is suitable for cloning.

In various embodiments, one or more hardening agents can be located (e.g., installed by administrators) on the master VM to perform hardening processes. An example of a hardening agent that can perform some hardening processes is the VMware® Carbon Black security agent. The VMware® Carbon Black security agent can perform a background scan of existing files and binaries on the master VM and carry out hardening processes such as an anti-virus scan, vulnerability assessment, and CIS (Center for Internet Security®) benchmark compliance checking.

Generally, once a hardening agent begins a process (e.g., the VMware® Carbon Black agent begins a scan), the process needs to be completed before the master VM is cloned, otherwise the clone may be susceptible to undiscovered vulnerabilities and the hardening process may continue on the cloned VM, thereby burdening its performance. However, hardening processes can take time and so tracking the progress and completion status of these processes becomes critical. For example, if a master VM is cloned while a hardening scan by the hardening agent is in progress, then the scan may need to be completed by the cloned VM, taking up valuable computing and network resources and slowing down the cloned VM. Also, the cloned VM may be exposed (e.g., by undetected viruses, vulnerabilities, etc.) that the scan did not catch because it was not complete. Hence, it is important that all hardening processes are complete before the master VM is cloned.

With previous technologies, to check if the defined hardening pre-requisites have been met, an administrator was required to log into the master VM using credentials and manually check the status of the processes, such as by using CLI (command line interface) based commands or via the GUI (graphical user interface). For example, to check the status of a VMware® Carbon Black background scan, an administrator needed to log into the master VM, use CLI commands to check the background scan status, enforce predefined policy, and then make manual decisions to determine if the master VM is ready to be cloned. This process involved multiple manual steps and has the potential of human errors. Hence, while the hardening agent (e.g., VMware® Carbon Black) might save the scan status in the master VM, this information was not trackable from outside the master VM with past technologies.

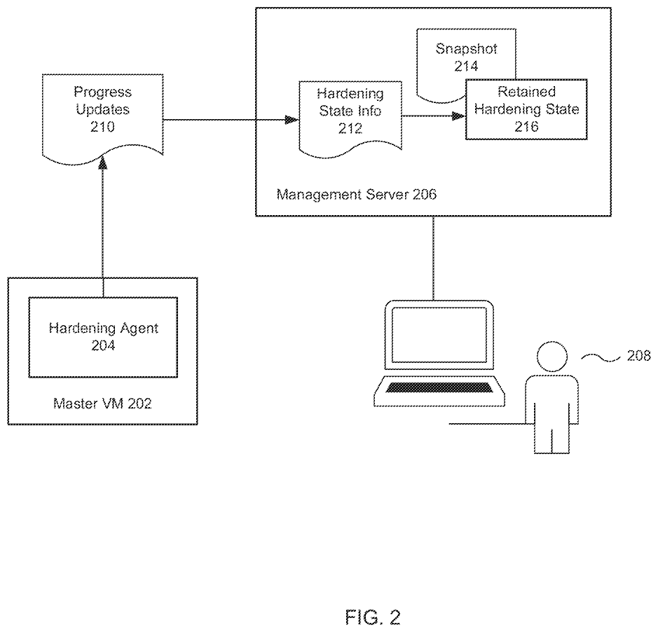

FIG. 2 illustrates an example architecture of a system for tracking and saving point-in-time hardening status of a master virtual machine, in accordance with various embodiments. As illustrated in the example of FIG. 2, the system can contain a master VM 202 that can be managed by an administrator 208 via a management server 206. The management server 206 can provide a centralized management platform and framework for all hosts and their respective VMs in the virtual desktop infrastructure. The management server 206 can allow IT administrators to deploy, manage, monitor, automate, and secure a virtual infrastructure in a centralized fashion. For example, a typical virtual infrastructure may include several host servers (such as the host servers 102-1, 102-2, and 102-N illustrated in the example of FIG. 1) and each host server can host multiple virtual machines that can be accessed by users on client devices. In such a deployment, the management server 206 can provide a centralized management platform and framework for managing all such hosts and their respective VMs. The management server 206 may provide a user interface that allows the administrator, through their client device, to login and access the server 206 and perform various management functions on the host servers, their hosted VMs, and other components in the virtual infrastructure.

An example of a management server is the VMware® vCenter Server, which provides a centralized management platform and framework for VMware® ESXi host servers and their respective VMs in a VMware® virtual infrastructure. In various embodiments, the management server 206 in the example of FIG. 2 can be a management server such as the VMware® vCenter Server, which can be modified and supplemented with certain functions and components to enable the functionality of this invention, as will be described in more detail below.

In various embodiments, the master VM 202 can be located on the management server 206, in other embodiments, the master VM 202 can be located on a host server that may be managed by the management server 206. When a master VM 202 is cloned, the clone VMs can be hosted on host servers that are managed by the management server 206 as well, which is not illustrated in the example of FIG. 2 so as not to obscure the salient features of the invention.

It should be noted that while the example of FIG. 2 illustrates a management server 206 and one master VM 202, in a real-world implementation the administrator 208 may maintain and manage several master VMs (to suit different purposes and different end-users) through the management server 206, and the procedures described with respect to the illustrated master VM 202 may similarly apply to other master VMs in the deployment. Likewise, the management server 206 may enable the administrator 208 to produce clones of master VMs and the cloned VMs may be hosted on host servers that are also managed by the management server 206 in the infrastructure. Via the management server 206, the administrator 208 may also be able to manage the cloned VMs that may be provisioned to users, which is also not illustrated so as not to obscure salient features of the invention.

As illustrated, the master VM 202 can contain a hardening agent 204, which can be a module configured to perform any of a variety of hardening processes on the master VM 202 as described above, such as an antivirus scan, vulnerability assessment, CIS benchmark compliance checking, OS setting checks, etc. In an embodiment, the hardening agent 204 can be an agent such as the VMware® Carbon Black security agent.

The hardening agent 204 can be launched (e.g., by the administrator 208) on the master VM 202 and execute to perform any of several predefined or pre-selected hardening processes. As the hardening agent 204 performs the hardening processes, it can generate progress updates 210 corresponding to each hardening process, which can be observed by the management server 206. In various embodiments, the hardening agent 204 can convey or otherwise share the progress updates with the management server 206 when they are generated. For example, a progress update can indicate that a particular process (e.g., antivirus scan) is at a certain percentage of completion. When the agent 204 generates a new progress update (e.g., recognizes a change in completion percentage of a process), the management server 206 can observe the update, or the agent 204 can send the progress update 210 to the management server 206. In various embodiments, the progress updates 210 can include information other than completion progress as well, such as warnings, notifications, description of issues encountered, etc.

In various embodiments, the management server 206 can track and save hardening state information 212 for the master VM 202 (e.g., in a list, a data structure, a file, etc.). Similarly, if multiple master VMs are being managed, the management server 206 can track the hardening state information for each master VM separately. The hardening state information 212 can indicate the state of the hardening of the master VM 202. For example, the hardening state info 212 can indicate the percentage completion of each hardening process that is being performed. In various embodiments, the administrators can define what hardening processes are tracked and saved in the hardening state information 212. In various embodiments, the hardening state information 212 of the master VM 202 (and of any other master VMs) can be accessible to the administrator 208; for example, via the management server 206 GUI. This way, the administrator 208 can check the current hardening state of the master VM 202 (or of any other managed master VMs) conveniently and without needing to access the master VM itself.

In various embodiments, the hardening state information 212 can further include the overall hardening progress. The overall hardening progress can be an estimate of the portion of all the hardening processes that has been completed where, for example, 100% represents all prerequisites being met and 0% represents zero progress towards any prerequisite being met. The overall hardening progress can be estimated, for example, by averaging the percent completion of all prerequisites.

Thus, when the management server observes or receives a progress update 210 from the hardening agent 204, it can update the stored hardening state information 212 for the master VM 202 based on the progress update. For example, the hardening state information 212 can include the percent completion for each of an antivirus scan, a vulnerability assessment, and a CIS benchmark check, each of which may be performed by the hardening agent 204 on the master VM 202. When the hardening agent 204 produces an update for a process (e.g., antivirus scan was 10% complete and is now 20% complete). This information can be observed by or conveyed to the management server 206 and the management server 206 can update the hardening state information 212 accordingly to indicate that the antivirus scan for the master VM 202 is 20% complete.

In various embodiments, when all hardening prerequisites have been met on the master VM 202, the management server 206 can change or set the status of the master VM to “ready to clone” and/or produce an indication that the master VM 202 is ready for cloning, which indication may inform the administrator 208 (e.g., in the GUI) that the master VM is ready to clone. For example, a set of prerequisites can be defined, e.g., by the administrator 208, and when the management server 206 determines that the prerequisites are satisfied, it can change the status and/or produce an indication that the master VM 202 is ready for cloning. Such prerequisites can be, for example, a list of hardening processes that need to be 100% complete for the master VM 202 to be deemed ready to clone. For example, the prerequisites may be the antivirus scan, the vulnerability assessment, and the CIS benchmark check. Then, once the hardening agent 204 completes all three processes, shares a corresponding update 210 with the management server 206, and the management server 206 determines that all the prerequisites have been satisfied, the master VM 202 status can be changed to “ready to clone” in the management server 206, and it can be indicated as being “ready to clone”.

The “ready to clone” indication can be produced in various ways in the management server 206. For example, when an admin views the master VM (or views a user interface (UI) element representing the master VM) in the graphical user interface (GUI) of the management server 206, the “ready to clone” status can be indicated in reference to the master VM by text, a symbol, a label, a description, or any other mechanism. In various embodiments, the hardening state information 212 can be set to indicate that the VM is ready to clone, such that an administrator 208 who accesses the VM's 202 hardening state information 212, would be able to immediately see that the VM 202 has met all the prerequisites without needing to confirm the completion of each prerequisite separately.

In various embodiments, when a snapshot 214 of the master VM 202 is produced, the “ready to clone” status can be stored or retained in the snapshot (e.g., in metadata), such that when an administrator accesses or views the snapshot, they will be informed that the master VM 202 is ready to clone. As will be appreciated by those skilled in the art, various approaches are possible for indicating to an administrator that the VM is ready for cloning after the VM has met all prerequisites and the invention is not limited to any particular approach.

In various embodiments, if the master VM 202 is powered off, the latest hardening state information 212 can be fixed and saved in the management server 206. The latest saved hardening state 212 before the master VM 202 is powered off can represent the current hardening state of the powered-off master VM 202 in the management server 206. This way, the administrator 208 can check the latest state of the hardening processes and the hardening state of the master VM 202 (e.g., whether it is ready to clone) at any given time irrespective of the power state of the master VM 202.

As mentioned above, VMs can be cloned from a snapshot 214 of a master VM (e.g., 202). For such reasons, snapshots of master VMs may be produced and stored on the management server 206 (e.g., by the administrator 208) so that they are ready for use when clones of the master VMs are needed. In various embodiments, when a snapshot 214 is created of the master VM 202 (e.g., by an administrator 208), the point-in-time hardening state 216 of the master VM 202 can be stored along with or be retained in the snapshot 214 automatically (e.g., in metadata). For example, when the management server 206 receives an instruction or a request to produce the snapshot 214, it can automatically include the hardening state 216 with the snapshot or in the metadata of the snapshot file. In various embodiments, the retained hardening state information 216 in the snapshot 214 can be the same as, or be obtained from, the saved hardening state information 212. Hence, the retained hardening state 216 in the snapshot 214 can indicate various information about the hardening state of the master VM 202 corresponding to the time when the snapshot 214 was produced, such as the status of the various prerequisites, the “ready to clone” status, the overall hardening progress, etc. This way, if the snapshot 214 is used to create clones in the future, the administrator 208 would know the status of the hardening (and whether the prerequisites have been met) before creating the clone VMs. For example, the administrator may be able to see the hardening status from the retained hardening state 216 when they access the snapshot 214, begin working with it, or when they open the snapshot 214 in the management server 206.

For example, in a system such as the VMware® vCenter Server, when a VM snapshot is taken, various metadata information can be created and stored on the snapshot itself. This metadata can contain information like snapshot name, time taken, etc. In various embodiments, this metadata space can be used to store the hardening state information 216. This way, the hardening state information 216 can become part of the snapshot itself. Then, when metadata information is displayed on the management server 206 to a user (e.g., to an admin), the hardening state information 216 can be displayed as well.

As mentioned previously, an efficient way to practice the invention can be to implement a traditional management server, such as the VMware® vCenter Server, that is modified or supplemented with additional components and/or functions to enable various features of this invention. One approach for achieving this utilizes a virtual appliance.

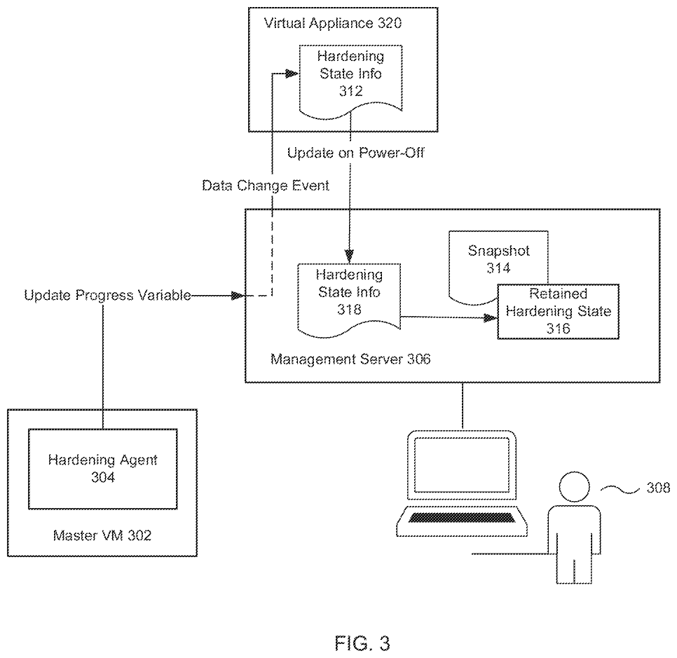

FIG. 3 illustrates an example architecture of a system for tracking and saving point-in-time hardening status of a master virtual machine implementing a virtual appliance, in accordance with various embodiments. Like the example of FIG. 2, the example of FIG. 3 includes a master VM 302 with a hardening agent 304 that can be executed (e.g., by the administrator 308) to run any of various hardening processes. In various embodiments, the system illustrated in the example of FIG. 3 can be analogous to the system illustrated in FIG. 2 and perform the same or analogous functions of tracking and saving point-in-time hardening status of a master VM as described above and with reference to the system of FIG. 2, except that the system illustrated in this example can employ a virtual appliance 320 connected to the management server 306 to facilitate the performance of various functions of the invention, as will be described in more detail below.

In various embodiments, the virtual appliance 320 in the example of FIG. 3 can be a pre-configured virtual machine image, ready to run on a hypervisor. The virtual appliance 320 can comprise a software application combined with sufficient operating system to run in a virtual machine. For example, the virtual appliance 320 can be created by installing a software appliance on a virtual machine and packaging that into an image to create the virtual appliance.

In various embodiments, the virtual appliance 320 can provide an efficient and reliable way to utilize an existing management server platform, such as a VMware® vCenter Server, (which may be modified as needed) and extend its functionality for performing the functions of this invention. Thus, the approach utilizing a virtual appliance may be preferable for practicing the invention in real-world settings. For example, in the case of the VMware® vCenter Server, while this management server can track hardening state information for master VMs that undergo hardening processes, it is not configured to store/persist this information. Instead, hardening state information is updated during the hardening process but remains as runtime information that is cleared on the management server once the VM is powered-off. Hence, with the VMware® vCenter Server, once the master VM gets powered off or restarted, the runtime hardening state information is lost. As will be described in further detail below, the virtual appliance can be used to persist back (e.g., to save or track) the hardening state information of a master VM for permanent storage, regardless of the master VM' s power-off/on state. Using the virtual appliance, hardening information can be permanently saved/persisted for the master VM when it is in a powered-off state and the hardening state information can become part of or be retained in a snapshot captured from the master VM as well (e.g., in file metadata).

As illustrated in the example of FIG. 3, the virtual appliance 320 can be connected to the management server 306. The management server 306 can be (or can be a modified version of) a traditional VDI central management server, such as the VMware® vCenter Server. Like the example of FIG. 2, a real-world implementation would generally include several master VMs, host servers, and user VMs, which are not illustrated.

In an embodiment, the virtual appliance 320 can be a virtual machine deployed on the management server 306. In other embodiments, the virtual appliance 320 can be a virtual machine deployed on another host server in the deployment (e.g., a host server managed by the management server 306) or elsewhere, provided there is a connection between the appliance 320 and the management server 306.

In various embodiments, when a hardening process runs inside the master VM 302 (e.g., executed by the hardening agent 304) the process can update its progress (e.g., percent completion, etc.) in a progress variable (e.g., a variable that tracks and saves the process progress status) on the virtual machine. For example, in a VMware® system, the process can update its progress in a “GuestInfo” variable using a VMware Tools utility on the virtual machine.

To enable tracking of hardening processes on the master VM 302, changes to the progress variable can be shared with or conveyed to the virtual appliance 320. For example, the virtual appliance 320 can be registered to receive any changes in the progress variable on virtual machines deployed on the management server 306. Once the virtual appliance 320 is registered for receiving progress variable changes, any insert/update/delete of a property in the guest variable can be sent to the virtual appliance 320 as a change notification event. With this infrastructure in place, the virtual appliance 320 and the management server 306 can track status of the hardening processes performed by the hardening agent 304 and the progress towards meeting hardening pre-requisites.

For example, in a in a VMware® system utilizing the VMware® vCenter Server, the virtual appliance 320 can be registered to receive any changes in GuestInfo properties, on virtual machines (e.g., master VM 302) deployed on the management server 306 (VMware® vCenter Server). This can be done using the property collector of VMware® vCenter Server. Once the virtual appliance 320 is registered for GuestInfo changes, any insert/update/delete of a property in GuestInfo can be sent to the virtual appliance 320 as a change notification event. With this infrastructure in place, the virtual appliance 320 and the VMware® vCenter Server can track status of the hardening processes performed by the hardening agent 304 and the progress towards meeting hardening pre-requisites.

Thus, as illustrated in the example of FIG. 3, when the hardening process in the master VM 302 updates the progress variable (e.g., GuestInfo), the update can be observed by the management server 306. Then, as illustrated, the management server 306 can forward the data change event to the virtual appliance 320. For example, the progress variable change (e.g., GuestInfo variable change) can be sent as a data change notification event to the virtual appliance 320 by the management server 306 (e.g., by the VMware® vCenter).

In various embodiments, the virtual appliance 320 can receive the data change events and use the data change events to maintain and track the progress of the hardening processes on the master VM 302. In a similar way, the virtual appliance can track the hardening process on other master VMs in the deployment. For example, the virtual appliance 320 can maintain hardening state information 312 of the master VM 302 (e.g., in a list, a data structure, a file, etc.). Similarly, if multiple master VMs are being managed, the virtual appliance 320 can track the hardening state information for each master VM separately. The hardening state information 312 can indicate the state of the hardening of the master VM 302. For example, the hardening state info 312 can indicate the percentage completion of each hardening process that is being performed. In various embodiments, the administrators can define what hardening processes are tracked and saved in the hardening state information 312. In various embodiments, the hardening state information 312 of the master VM 302 (and of any other master VMs) can be accessible to the administrator 308; for example, via the management server 306 GUI. This way, the administrator 308 can check the current hardening state of the master VM 302 (or of any other managed master VMs).

Thus, when the virtual appliance 320 receives a data change event corresponding to a hardening process on the master VM 302 from management server 306, it can update the hardening state information 312 for the master VM 302 based on the data change event. For example, the hardening state information 312 can include the percent completion for each of an antivirus scan, a vulnerability assessment, and a CIS benchmark check, each of which may be performed by the hardening agent 304 on the master VM 302. When the hardening agent 304 updates a progress variable (e.g., antivirus scan was 10% complete and is now 20% complete), the update can be observed by the management server 306. This information can then be conveyed to the virtual appliance 320 (e.g., by the management server 306) as a data change event and the virtual appliance 320 can update the hardening state information 312 accordingly to indicate that the antivirus scan for the master VM 302 is 20% complete.

In various embodiments, when the virtual appliance 320 detects that all hardening prerequisites have been met on the master VM 302, the virtual appliance 320 can update the management server 306 with a “ready to clone” status or produce an indication that the master VM 302 is ready for cloning. For example, a set of prerequisites can be defined, e.g., by an administrator 308 and the list of required prerequisites can be saved in the virtual appliance 320. When the virtual appliance 320 determines that the prerequisites are satisfied on the master VM 302, it can update the status of the master VM 302 on the management server 306 to “ready to clone” (e.g., by sending a message or request to the management server 306). The management server 306 can also produce an indication that the master VM 302 is ready to clone, as described previously. Such prerequisites can be, for example, a list of hardening processes that need to be 100% complete for the master VM 302 to be deemed ready to clone. For example, the prerequisites may be that the antivirus scan, the vulnerability assessment, and the CIS benchmark check are complete. Then, once the hardening agent 304 completes all three processes and a corresponding update is conveyed to the virtual appliance 320 via the management server 306, the virtual appliance 320 can request the management server 306 to set the master VM 302 status to “ready to clone”.

In various embodiments, the management server 306 can also maintain hardening state information 318 of the master VM 302 in permanent storage (e.g., in a list, a data structure, a file, etc.), as well as of other master VMs that may be managed by the management server 306. If the master VM 302 is powered off (e.g., in response to it being powered-off), the latest hardening state information 312 for the master VM 302 stored in the virtual appliance 320 can be conveyed to the management server 206 for permanent storage and the hardening state information 318 can be saved. The hardening state information 318 on the management server 306 can then represent the current hardening state of the powered-off master VM 302. This way, the administrator 308 can check the latest state of the hardening processes and the hardening state of the master VM 302 (e.g., whether it is ready to clone) at any given time irrespective of the power state of the master VM 202. For example, if the master VM 302 is powered off, the latest state of progress made by each hardening process towards satisfying a prerequisite inside the master VM 302 (as well as the overall hardening progress) can be updated by the virtual appliance 320 on the management server 306 (and saved in the hardening state information 318) after the master VM 302 powers off. The overall hardening progress can also be updated in the hardening state information 318 on the management server 306. The overall hardening progress can be an estimate of the portion of all the hardening processes that has been completed where, for example, 100% represents all prerequisites being met and 0% represents zero progress towards any prerequisite being met. The overall hardening progress can be estimated, for example, by averaging the percent completion of all prerequisites.

In various embodiments, when a snapshot 314 is created of the master VM 302 (e.g., by an administrator 308), the point-in-time hardening state 316 of the master VM 302 can be stored along with or be retained in the snapshot 314 automatically (e.g., in metadata). In various embodiments, the retained hardening state information 316 in the snapshot 314 can be the same as, or be obtained from, the saved hardening state information 318 on the management server 306. Hence, the retained hardening state 316 in the snapshot 314 can indicate various information about the hardening state of the master VM 302 corresponding to the time when the snapshot 314 was produced, such as the status of the various prerequisites, the “ready to clone” status, the overall hardening progress, etc. This way, if the snapshot 314 is used to create clones in the future, the administrator 308 would know the status of the hardening (and whether the prerequisites have been met) before creating the clone VMs. For example, the administrator may be able to see the hardening status from the retained hardening state 316 when they access the snapshot 314, begin working with it, or when they open the snapshot 314 in the management server 306.

In various embodiments, when a snapshot 314 of the master VM 302 is produced, the “ready to clone” status can be stored or retained in the snapshot, such that when an administrator accesses or views the snapshot, they will be informed that the master VM 302 is ready to clone. As will be appreciated by those skilled in the art, various approaches are possible for indicating to an administrator that the VM is ready for cloning after the VM has met all prerequisites and the invention is not limited to any particular approach.

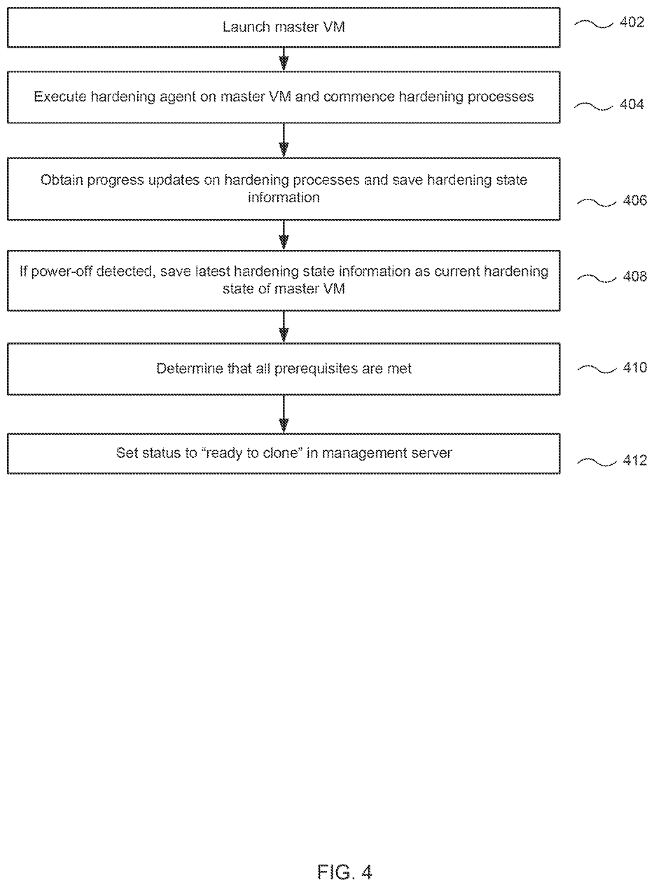

FIG. 4 illustrates an example process flow for tracking and saving point-in-time hardening status of a master virtual machine, in accordance with various embodiments. The process can begin in operation 402, where a master VM is launched. For example, the master VM can be hosted on a management server or on a host server managed by the management server and an administrator can launch the VM. In operation 404, a hardening agent can be executed on the master VM (e.g., by the administrator), and the hardening agent can commence performing hardening processes.

In operation 406, progress updates on the hardening processes can be obtained and the hardening state information can be saved. For example, the hardening agent can produce progress updates corresponding to the hardening processes and the management server can obtain these updates and use them to track the hardening state information. In various embodiments, changes in hardening progress statuses can be conveyed to a virtual appliance and the virtual appliance can track the hardening state information.

In operation 408, if it is detected that the master VM is powered off (e.g., by the management server), then the latest hardening state information can be saved as the current hardening state of the powered-off master VM. For example, the saved hardening state information can indicate any of the completion progress (e.g., percent of completion) of each prerequisite hardening process, the overall hardening completion progress, and the “ready to clone” status of the master VM. This way, an administrator may check the hardening state information of the VM without needing to power it on. Further, at this point if a snapshot of the master VM is produced, the current hardening state information can be retained with the snapshot or in the snapshot (e.g., in metadata) to inform an administrator of the hardening state of the master VM corresponding to the produced snapshot.

In various embodiments, a master VM power-off in operation 408 can include different types of events. For example, a power-off can include the VM being shut-down (either manually, automatically, inadvertently, etc.) or restarted. A power-off can also include the VM becoming non-responsive, such as due to an error or crash. Hence, when such events are detected, in operation 408, the latest hardening state information can be saved as the current hardening state of the powered-off master VM.

In operation 410, it can be determined that all the prerequisites are met. For example, the management server (or the virtual appliance on the management server) can determine that all prerequisite hardening processes are complete. For example, the administrator may define which hardening process are required and therefore considered “prerequisites”. In operation 412, in response to determining that all prerequisites have been met, the status of the master VM can be set to “ready to clone” in the management server to indicate that the master VM is ready for cloning.

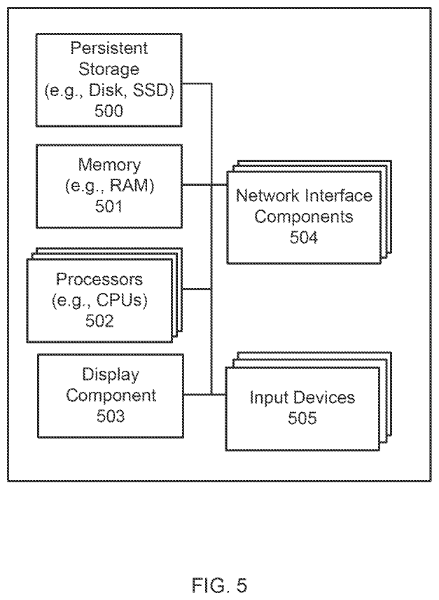

FIG. 5 illustrates an example of some general components of a computing device, in accordance with various embodiments. In this particular example, the device includes one or more processors (e.g., central processing units (CPUs) 502 for executing instructions that can be stored in a storage medium component. The storage medium can include many types of memory, persistent data storage, or non-transitory computer-readable storage media. For example, the storage medium may take the form of random access memory (RAM) 501 storing program instructions for execution by the processor(s) 502, a persistent storage (e.g., disk or SSD) 500, a removable memory for sharing information with other devices and/or the like. The computing device typically can further comprise a display component 503, such as a monitor, a touch screen, liquid crystal display (LCD), or the like. In various embodiments, the computing device will include at least one input device 505 able to receive conventional input from a user. This conventional input can include, for example, a push button, touch pad, touch screen, wheel, joystick, keyboard, mouse, keypad, or any other such device or element whereby a user can input a command to the device. In some embodiments, the computing device can include a network interface component (NIC) 504 for communicating over various networks, such as a Wi-Fi®, Bluetooth®, RF, wired, or wireless communication systems. The device in many embodiments can communicate over a network, such as the Internet, and may be able to communicate with other devices connected to the same or other network.

Various embodiments described herein can be implemented in a wide variety of environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Many embodiments utilize at least one network that would be familiar to those skilled in the art for supporting communications using any of a variety of commercially-available protocols, such as TCP/IP, FTP, UDP or the like. The network can be, for example, a local area network, a wide-area network, a virtual private network, the Internet, an intranet, an extranet, a public switched telephone network, an infrared network, a wireless network, and any combination thereof.

The various environments in which the embodiments can be implemented may include a variety of data stores and other memory and storage media, as discussed above. These can reside in a variety of locations, such as on a storage medium local to one or more of the computers or remote from any or all of the computers across the network. In some embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for tracking hardening state of a virtual machine (VM) on a management server, comprising:
launching the VM and executing a hardening agent on the VM, the hardening agent being configured to perform one or more processes for hardening the VM;
by the hardening agent executing on the VM:
initiating the one or more hardening processes on the VM; and
producing a progress update corresponding to the one or more hardening processes;
by the management server, updating hardening state information for the VM based on the progress update produced by the hardening agent;
detecting a power-off of the VM; and
in response to the power-off, saving the hardening state information as current hardening state information corresponding to the powered-off VM on the management server, wherein the hardening state information is accessible to a user on the management server while the VM is powered off.

2. The method of claim 1, further comprising:
determining that all prerequisite hardening processes have been completed on the VM; and
in response to determining that all the prerequisite hardening processes have been completed, setting a status of the VM on the management server indicating that it is ready to be cloned.

3. The method of claim 1, wherein the saved hardening state information is retained in metadata of a snapshot that is created of the VM.

4. The method of claim 1, wherein the saved hardening state information comprises a completion progress corresponding to each of one or more prerequisite hardening processes, wherein the one or more prerequisite hardening processes are required to be completed before the status of the VM on the management server is set to indicate that it is ready to be cloned.

5. The method of claim 1, wherein the saved hardening state information comprises an indication of whether the VM is ready to be cloned.

6. The method of claim 1, wherein:
the progress update corresponding to the one or more hardening processes is conveyed to a virtual appliance connected to the management server;
the virtual appliance stores and updates the hardening state information for the VM based on the progress update; and
upon detecting the power-off of the VM, the virtual appliance conveys the hardening state information for the VM to the management server for permanent storage on the management server.

7. The method of claim 1, wherein the one or more hardening processes comprises an antivirus scan and a vulnerability assessment.

8. A computing device for tracking hardening state of a virtual machine (VM) on a management server, comprising:
at least one processor; and
memory including instructions that, when executed by the at least one processor, cause the computing device to perform the steps of:
launching the VM and executing a hardening agent on the VM, the hardening agent being configured to perform one or more processes for hardening the VM;
by the hardening agent executing on the VM:
initiating the one or more hardening processes on the VM; and
producing a progress update corresponding to the one or more hardening processes;
by the management server, updating hardening state information for the VM based on the progress update produced by the hardening agent;
detecting a power-off of the VM; and
in response to the power-off, saving the hardening state information as current hardening state information corresponding to the powered-off VM on the management server, wherein the hardening state information is accessible to a user on the management server while the VM is powered off.

9. The computing device of claim 8, wherein the memory further includes instructions that when executed by the at least one processor, cause the computing device to perform the steps of:
determining that all prerequisite hardening processes have been completed on the VM; and
in response to determining that all the prerequisite hardening processes have been completed, setting a status of the VM on the management server indicating that it is ready to be cloned.

10. The computing device of claim 8, wherein the saved hardening state information is retained in metadata of a snapshot that is created of the VM.

11. The computing device of claim 8, wherein the saved hardening state information comprises a completion progress corresponding to each of one or more prerequisite hardening processes, wherein the one or more prerequisite hardening processes are required to be completed before the status of the VM on the management server is set to indicate that it is ready to be cloned.

12. The computing device of claim 8, wherein the saved hardening state information comprises an indication of whether the VM is ready to be cloned.

13. The computing device of claim 8, wherein:
the progress update corresponding to the one or more hardening processes is conveyed to a virtual appliance connected to the management server;
the virtual appliance stores and updates the hardening state information for the VM based on the progress update; and
upon detecting the power-off of the VM, the virtual appliance conveys the hardening state information for the VM to the management server for permanent storage on the management server.

14. The computing device of claim 8, wherein the one or more hardening processes comprises an antivirus scan and a vulnerability assessment.

15. A non-transitory computer readable storage medium for tracking hardening state of a virtual machine (VM) on a management server comprising one or more sequences of instructions, the instructions when executed by one or more processors causing the one or more processors to execute the operations of:
launching the VM and executing a hardening agent on the VM, the hardening agent being configured to perform one or more processes for hardening the VM;
by the hardening agent executing on the VM:
initiating the one or more hardening processes on the VM; and
producing a progress update corresponding to the one or more hardening processes;
by the management server, updating hardening state information for the VM based on the progress update produced by the hardening agent;
detecting a power-off of the VM; and
in response to the power-off, saving the hardening state information as current hardening state information corresponding to the powered-off VM on the management server, wherein the hardening state information is accessible to a user on the management server while the VM is powered off.

16. The non-transitory computer readable storage medium of claim 15, further comprising instructions that when executed by the one or more processors cause the one or more processors to execute the operations of:
determining that all prerequisite hardening processes have been completed on the VM; and
in response to determining that all the prerequisite hardening processes have been completed, setting a status of the VM on the management server indicating that it is ready to be cloned.

17. The non-transitory computer readable storage medium of claim 15, wherein the saved hardening state information is retained in metadata of a snapshot that is created of the VM.

18. The non-transitory computer readable storage medium of claim 15, wherein the saved hardening state information comprises a completion progress corresponding to each of one or more prerequisite hardening processes, wherein the one or more prerequisite hardening processes are required to be completed before the status of the VM on the management server is set to indicate that it is ready to be cloned.

19. The non-transitory computer readable storage medium of claim 15, wherein an indication of whether the VM is ready to be cloned is retained in metadata of a snapshot that is created of the VM.

20. The non-transitory computer readable storage medium of claim 15, wherein:
the progress update corresponding to the one or more hardening processes is conveyed to a virtual appliance connected to the management server;
the virtual appliance stores and updates the hardening state information for the VM based on the progress update; and
upon detecting the power-off of the VM, the virtual appliance conveys the hardening state information for the VM to the management server for permanent storage on the management server.
